(19) United States
(12) Patent Application Publication
(10) Pub. No.: US 2022/0013924 A1
(43) Pub. Date: Jan. 13, 2022

(54) ANTENNA ARRANGEMENT FOR AN UNMANNED AERIAL VEHICLE

(71) Applicant: Telefonaktiebolaget LM Ericsson (publ), Stockholm (SE)

(72) Inventor: Andreas NILSSON, Göteborg (SE)

(21) Appl. No.: 17/293,135

(22) PCT Filed: Nov. 15, 2018
(86) PCT No.: PCT/EP2018/081379

§ 371 Date: May 12, 2021

(51) Int. Cl. H01Q 21/30; H04B 7/06; H04B 7/08; H04B 7/185; H01Q 3/30; H01Q 21/06; H01Q 1/28

(52) U.S. Cl. CPC H01Q 21/30; H04B 7/0608; H04B 7/0814; H01Q 1/28; H04B 7/18515; H01Q 3/30; H01Q 21/06; H04B 7/18504

(57) ABSTRACT

Some embodiments disclosed herein relate to an unmanned aerial vehicle (UAV). The UAV comprises an antenna arrangement. The antenna arrangement comprises a first antenna array. The first antenna array has antenna elements pointing in a first direction. The antenna arrangement comprises a second antenna array. The second antenna array has antenna elements pointing in a second direction opposite the first direction. The antenna arrangement comprises a baseband unit. The antenna arrangement comprises a switch configured to selectively connect the first antenna array and the second antenna array one at a time to the baseband unit. The antenna arrangement is arranged in the UAV such that the first direction equals the direction of gravitational force.

### TECHNICAL FIELD

Embodiments presented herein relate to an unmanned aerial vehicle (UAV), as well as to a method, a control node, a computer program, and a computer program product for controlling the UAV.

### BACKGROUND

UAVs, also referred to as called drones, have become more and more common for different applications. Some applications are aerial surveillance, professional aerial surveying, commercial and motion picture filmmaking, news gathering for journalism, observation by police forces, search and rescue operations, scientific research, disaster relief, passenger transportation, cargo transportation, etc.

It is expected, such as for safety and performance reasons, that future UAVs could be configured to be operatively connected to wireless terrestrial communication systems, such as cellular or non-cellular to wireless terrestrial communication systems. However, there is a risk that international as well as national restrictions and/or regulations will prohibit the future uses of UAVs due to potential problems. One concerns relates to that UAVs communicating with wireless terrestrial communication systems might create intolerable levels of interference in the wireless terrestrial communication, potentially resulting in service interruptions for other users, such as for normal cell phone services. One reason that UAVs creates so much interference is due to that UAVs typically fly quite high up in the air and therefore simultaneously experiences line-of sight channels to multiple radio base stations in the terrestrial communication system. That is, in some scenarios, whenever the UAV transmit signals, it might cause strong interference to neighboring radio base stations. Due to this issues, UAVs might even be prohibited from connecting to cellular terrestrial communication systems as they otherwise might ruin the performance for the whole terrestrial communication system.

One way to mitigate the issue of UAVs generating intolerable levels of interference (and at the same time improve the network coverage for the UAV) is to utilize antenna systems capable of so-called beamforming at the UAV. In this way the UAV can generate a narrow high-gain beam to the serving radio base station and in this way focus the energy in that direction. However, generating narrow beams typically requires a large antenna aperture relative the wavelength which makes it practically difficult to implement such antenna systems for UAVs communicating at lower frequencies.

In view of the above it could be cumbersome to communicate with UAVs. Hence, there is still a need for improved mechanisms for communicating with UAVs

### SUMMARY

An object of embodiments herein is to enable efficient communication with UAVs.

According to a first aspect there is presented a UAV. The UAV comprises an antenna arrangement. The antenna arrangement comprises a first antenna array. The first antenna array has antenna elements pointing in a first direction. The antenna arrangement comprises a second antenna array. The second antenna array has antenna elements pointing in a second direction opposite the first direction. The antenna arrangement comprises a baseband unit. The antenna arrangement comprises a switch configured to selectively connect the first antenna array and the second antenna array one at a time to the baseband unit. The antenna arrangement is arranged in the UAV such that the first direction equals the direction of gravitational force.

According to a second aspect there is presented a method for controlling a UAV according to the first aspect. The switch in a first position connects the first antenna array to the baseband unit and in a second position connects the second antenna array to the baseband unit. The method is performed by a control node. The method comprises controlling movement of the switch between the first position and the second position according to a control command.

According to a third aspect there is presented control node for controlling a UAV according to the first aspect. The switch in a first position connects the first antenna array to the baseband unit and in a second position connects the second antenna array to the baseband unit. The control node comprises processing circuitry. The processing circuitry is configured to cause the control node to control movement of the switch between the first position and the second position according to a control command.

According to a fourth aspect there is presented a computer program for controlling a UAV according to the first aspect, the computer program comprising computer program code which, when run on a control node, causes the control node to perform a method according to the second aspect.

According to a fifth aspect there is presented a computer program product comprising a computer program according to the fourth aspect and a computer readable storage medium on which the computer program is stored. The computer readable storage medium could be a non-transitory computer readable storage medium.

Advantageously this enables efficient communication with the UAV.

Advantageously this enables the UAV to switch between terrestrial and space coverage and/or capacity as needed.

Advantageously, by using a switch between the baseband unit and the two antenna arrays, only a single baseband unit is needed, which will reduce the cost of the UAV.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communication system according to embodiments;

FIGS. 2 and 3 schematically illustrate unmanned aerial vehicles according to embodiments;

FIGS. 4 and 5 are flowcharts of methods according to embodiments;

FIG. 6 is a schematic diagram showing functional units of a control node according to an embodiment;

FIG. 7 is a schematic diagram showing functional modules of a control node according to an embodiment; and

FIG. 8 shows one example of a computer program product comprising computer readable storage medium according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art.

Like numbers refer to like elements throughout the description. Any step or feature illustrated by dashed lines should be regarded as optional.

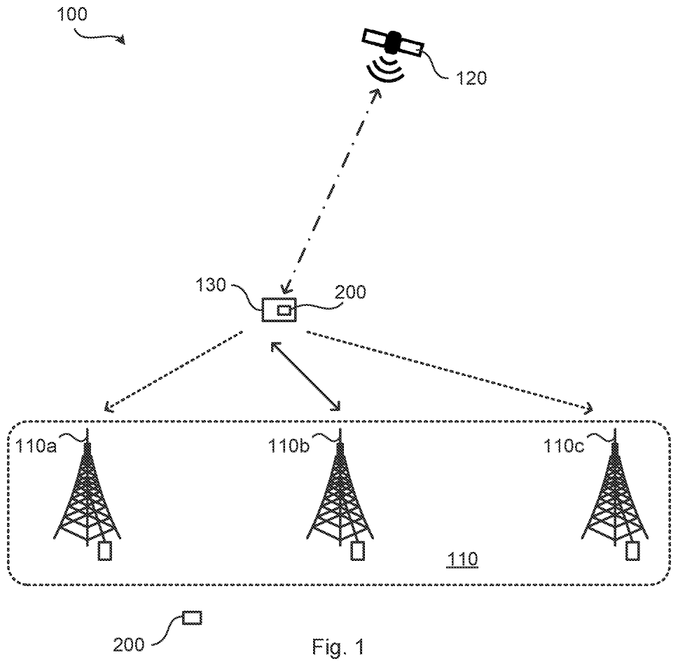

FIG. 1 is a schematic diagram illustrating a general communication system 100 where embodiments presented herein can be applied. The communication system 100 comprises a first communication system 110 and a second communication system 120. A UAV 130 is configured to selectively communicate with one of the first communication system 110 and the second communication system 120, respectively. That is, the UAV 130 is configured to communicate with the first communication system 110 and the second communication system 120 one at a time. FIG. 1 further illustrates a control node 200. Details of the control node 200 will be provided below.

In the illustrative examples of FIG. 1, the first communication system 110 is a terrestrial based communication system and the second communication system 120 is a space based communication system. Examples of the first communication system 110 and the second communication system 120 will be provided below. In the illustrative examples of FIG. 1, the first communication system 110 comprises radio base stations 110a, nob, 100c with which the UAV 130 thus is configured to communicate. Non-limiting examples of radio base stations 110a, 110b, 100c are radio access network nodes, base transceiver stations, node Bs, evolved node Bs, gNode Bs, access points, access nodes, and transmission and reception points.

In the illustrative examples of FIG. 1, the UAV 130 could have an ongoing communication with radio base station nob (as illustrated by the solid double-directed arrow in FIG. 1), but due to the line of sight, this might cause intolerable interference to the neighbouring radio base stations ioa, noc (as illustrated by the dotted double-directed arrows in FIG. 1). As will be further disclosed below, the antenna arrangement of the UAV 130 therefore comprises a switch which enables the UAV 130 to establish communication with the space based communication system (as illustrated by the dash-dotted double-directed arrow in FIG. 1), thereby reducing the interference caused.

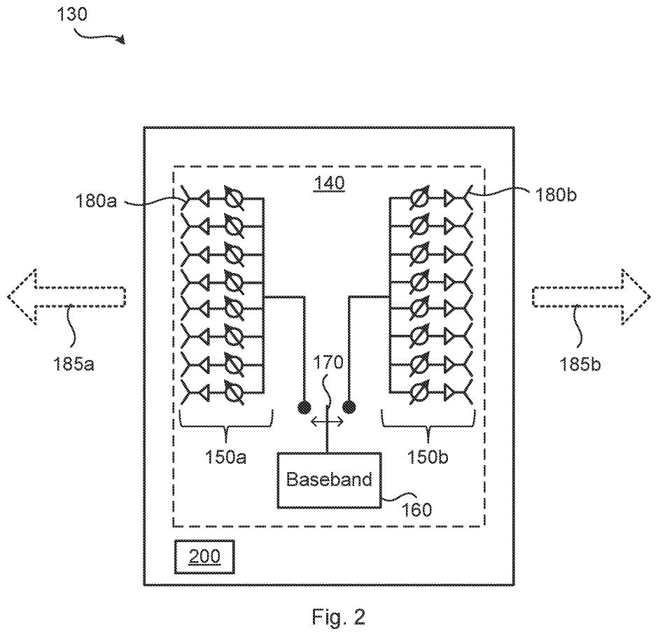

Reference is now made to FIG. 2. FIG. 2 schematically illustrates a UAV 130 according to an embodiment. The UAV 130 comprises an antenna arrangement 140.

The antenna arrangement 140 comprises a first antenna array 150a. The first antenna array 150a has antenna elements 180a pointing in a first direction, as indicated by arrow 185a. The antenna arrangement 140 further comprises a second antenna array 150b. The second antenna array 150b has antenna elements 180b pointing in a second direction, as indicated by arrow 185b. The second direction is opposite the first direction.

The antenna arrangement 140 further comprises a baseband unit 160. The antenna arrangement 140 further comprises a switch 170 configured to selectively connect the first antenna array 150a and the second antenna array 150b one at a time to the baseband unit 160.

The antenna arrangement 140 is arranged in the UAV 130 such that the first direction equals the direction of gravitational force. In other words, one of the antenna arrays 150a, 150b point upwards whilst the other of the antenna arrays 150a, 150b point downwards. It is here understood that the antenna arrangement 140 is arranged in the UAV 130 such that the first direction equals the direction of gravitational force during operation of the UAV 130.

Further aspects, embodiments, and examples of the UAV 130 and the antenna arrangement 140 will now be disclosed.

Examples of the first communication system and the second communication system will now be provided.

In some examples the first communication system 110 is a terrestrial based communication system. There could be different types of terrestrial based communication system. For example, the terrestrial based communication system might be a cellular communication system (such as a third generation telecommunication system, a fourth generation telecommunication system, or a fifth generation telecommunication system), or a non-cellular wide-area network, or a local area network for example based on the IEEE 802.11 standards.

In some examples the second communication system 120 is a space based communication system. There could be different types of space based communication system. For example, the space based communication system might be a satellite communication system, or a cellular communication system.

There could be different types of antenna arrays 150a, 150b.

At least one of the first antenna array 150a and the second antenna array 150b could be a uniform linear array, a uniform rectangular array, or a panel. In general terms, a panel is a rectangular antenna array of single- or dual-polarized antenna elements with typically one transmit/receive unit (TXRU) per polarization. An analog distribution network with phase shifters can be used to steer the beam of each panel. Alternatively, one or both antenna arrays 150a, 150b might have just one single antenna element 180a, 180b.

Further, at least one of the first antenna array 150a and the second antenna array 150b is configured for communication using beam-formed beams. The beamforming could be implemented using analog beamforming, digital beamforming, or hybrid beamforming.

In general terms, the antenna element spacing of the antenna elements 180a, 180b in each of the antenna arrays 150a, 150b is between 0.5-3 times the wavelength of the carrier frequency of the intended signal transmission (and reception) at the antenna arrays 150a, 150b. The antenna element spacing thus generally depends on the frequency band in which the antenna arrays 150a, 150b are intended to operate in. In some aspects the antenna arrays 150a, 150b have the same antenna element spacing. In other aspects the antenna arrays 150a, 150b have different antenna element spacing. That is, according to an embodiment, wherein the antenna elements 180a of the first antenna array 150a have different antenna element spacing than the antenna elements 180b of the second antenna array 150b.

In general terms, both the antenna arrays 150a, 150b might be configured to operate in one or more frequency bands in the frequency interval from 700 MHz to 60 GHz. In some aspects the antenna arrays 150a, 150b operate in different frequency bands. That is, according to an embodiment, the first antenna array 150a is configured to operate in a first frequency band, and wherein the second antenna array 150b is configured to operate in a second frequency band, different from the first frequency band. In this respect the first frequency band and the second frequency band might be partly overlapping or separated from each other. In particular, the second antenna array 150b might be configured at least for operating in the frequency band between 700 MHz and 5000 MHz, and/or in the frequency band between 1500 MHz and 1700 MHz. The first antenna array 150a might be configured to operate in one or more frequency bands below or above these frequency bands, or in one or more frequency bands at least partly overlapping with these frequency bands.

In general terms, the switch 170 is movable between a first position and a second position. Particularly, according to an embodiment the switch 170 in the first position connects the first antenna array 150a to the baseband unit 160 and in the second position connects the second antenna array 150b to the baseband unit 160.

There could be different default positions for the switch 170. In some aspects the switch 170 has a default position that enables the first antenna array 150a to be connected to the baseband unit 160. That is, according to an embodiment the switch 170 as a default is positioned in the first position. Thereby, in this default position the baseband unit 160 is connected to the antenna array 150a pointing downwards. The UAV 130 could thereby be operatively connected to the terrestrial communication system in normal use, but when needed, the UAV 130 switches to instead be operatively connected to the space communication system. In other aspects the switch 170 has a default position that enables the second antenna array 150b to be connected to the baseband unit 160. That is, according to an embodiment the switch 170 as a default is positioned in the second position. Thereby, in this default position the baseband unit 160 is connected to the antenna array 150b pointing upwards. The UAV 130 could thereby be operatively connected to the space communication system during normal operation but when it needs to send/receive much data it switches to the terrestrial communication system since space communication systems typically are slow and/or expensive to use.

As will be further disclosed below, in some aspects the switch 170 is controlled by a control node 200. In some aspects the control node 200 is provided in the UAV 130. Particularly, according to an embodiment the UAV 130 comprises a control node 200. The control node 200 is configured to control movement of the switch 170 between the first position and the second position upon obtaining a control command. Further aspects of the control node 200 and how it might control movement of the switch 170 will be disclosed below.

In addition to, or as an alterative to, that the antenna arrays 150a, 150b might have different antenna element spacing and/or operate in different frequency bands, the antenna arrays 150a, 150b might communicate with communication systems of different types. Particularly, according to an embodiment the first antenna array 150a is configured for communication with a first communication system 110 of a first type, and the second antenna array 150b is configured for communication with a second communication system 120 of a second type, different from the first type. Examples of such communication systems 110, 120 will be disclosed below.

Further, there could be different criteria for moving the switch 170 between the first position and the second position, and thus different types of control commands that the control node 200 might obtain. According to an embodiment the control node 200 is configured to control movement of the switch 170 from the first position to the second position upon the control command pertaining to a first indication of: network overload in the first communication system 110, interference in the first communication system 110 being above an interference threshold value, or lost network access to the first communication system 110. These are thus examples of some issues that the first communication system 110 might suffer from. There could be different causes of the interference. In some examples the interference is caused by the UAV 130 itself. Thereby, in case the first communication system 110 experiences heavy traffic the UAVs 130 can instead be connected to the second communication system 120, thereby enabling capacity in the first communication system 110 to be freed, and the interference generation towards the first communication system 110 to be reduced. Further, according to an embodiment the control node 200 is configured to control movement of the switch 170 from the second position to the first position upon the control command pertaining to a second indication of: the network overload having been alleviated, the interference having been alleviated, or the network access having been regained.

In this respect, there might be different ways for the control node 200 to obtain the second indication. For example, the control node 200 might be configured to temporarily move the switch 160 to the first position in order to probe the first communication system 110 for investigating whether the first communication system 110 suffers from any of the issues listed above, thereby obtaining the second indication. If the probing reveals that the first communication system 110 still suffers from any of these issues the switch 160 could be kept in the second position until a next probing instance.

Reference is now made to FIG. 3. FIG. 3(a) schematically illustrates a top view, and FIG. 3(b) a side view, of a UAV 130 according to an embodiment.

In the examples of FIG. 3 the UAV 130 further comprises sets of rotor blades 190a, 190b, 190c, 190d. The antenna arrangement 140 might then be placed such that its line of sight direction is not obstructed by the rotor blades 190a, 190b, 190c, 190d. That is, according to this embodiment the antenna arrangement 140 and the sets of rotor blades 190a, 190b, 190c, 190d are mutually arranged in the UAV 130 for the second antenna array 150b to have free line of sight in the second direction. In the example of FIGS. 3(a) and 3(b) the second antenna array 150b has been located on the top of the UAV 130 such that the rotor blades 190a, 190b, 190c, 190d do not interfere with the communication link to the second communication system) whereas the first antenna array 150a has been located on the bottom of the UAV 130.

Further, in the example of FIG. 3 the first antenna array 150a uses a beam-formed beam 195a for communication (such as for at least one of transmission and reception of signals) and the second antenna array 150b uses a beam-formed beam 195b for communication.

The embodiments disclosed herein further relate to mechanisms for controlling the UAV 130. In order to obtain such mechanisms there is provided a control node 200, a method performed by the control node 200, a computer program product comprising code, for example in the form of a computer program, that when run on a control node 200, causes the control node 200 to perform the method.

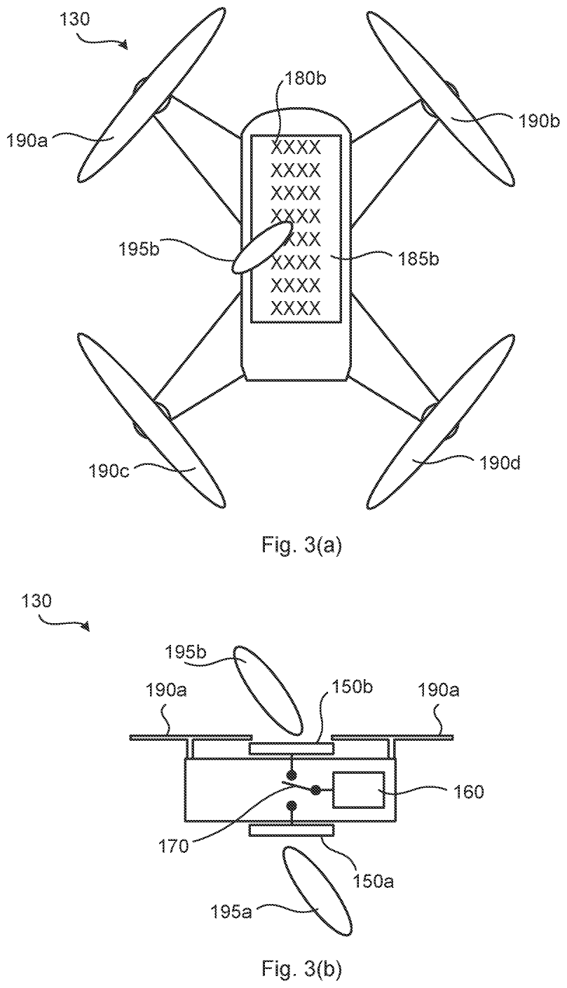

FIG. 4 is a flowchart illustrating embodiments of methods for controlling a UAV 130 as disclosed above. The methods are performed by the control node 200. The methods are advantageously provided as computer programs 820.

As disclosed above, the switch 170 in a first position connects the first antenna array 150a to the baseband unit 160 and in a second position connects the second antenna array 150b to the baseband unit 160.

S104: The control node 200 controls movement of the switch 170 between the first position and the second position according to a control command.

Embodiments relating to further details of controlling the UAV 130 as performed by the control node 200 will now be disclosed.

As disclosed above, in an embodiment the first antenna array 150a is configured for communication with a first communication system 110 of a first type, and the second antenna array 150b is configured for communication with a second communication system 120 of a second type, different from the first type.

As disclosed above the control node 200 could be configured to control movement of the switch 170 between the first position and the second position upon obtaining an indication. Hence, according to an embodiment, the control node 200 is configured to perform (optional) step S102a: S102a: The network node 200 obtains a first indication of: network overload in the first communication system 110, interference in the first communication system 110 being above an interference threshold value in the first communication system 110, or lost network coverage to the first communication system 110.

In this embodiment, the control command pertains to controlling movement of the switch 170 from the first position to the second position. Hence, in this embodiment the control node 200 is configured to control the movement in step S104 by performing (optional) step S104a: S104a: The control node 200 controls movement of the switch 170 from the first position to the second position in response thereto (i.e., in respect to having obtained the first indication in step S102a).

Further, according to an embodiment, the control node 200 is configured to perform (optional) step S102b: S102b: The network node 200 obtains a second indication of: the network overload having been alleviated, the interference having been alleviated, or the network coverage having been regained.

In this embodiment, the control command pertains to controlling movement of the switch 170 from the second position to the first position. Hence, in this embodiment the control node 200 is configured to control the movement in step S104 by performing (optional) step S104a: S104b: The control node 200 controls movement of the switch 170 from the second position to the first position in response thereto.

One particular embodiment for controlling the UAV 130 based on at least some of the above disclosed embodiments will now be disclosed with reference to the flowchart of FIG. 5.

S202: The UAV 130 communicates with the first communication system 110 by the switch 170 being in the first position, whereby the baseband unit 160 is connected to the first antenna array 150a.

S204: The control node 200 checks whether a first indication of network overload in the first communication system 110, interference in the first communication system 110 being above an interference threshold value, or lost network access to the first communication system 110 has been obtained or not. If yes, step S206 is entered; and if no, step S202 is entered. One way to implement step S204 is to perform step S102a.

S206: Movement of the switch 170 is controlled such that the switch moves from the first position to the second position. One way to implement step S206 is to perform step S104a.

S208: The UAV 130 communicates with the second communication system 120 by the switch 170 being in the second position, whereby the baseband unit 160 is connected to the second antenna array 150b.

S210: The control node 200 checks whether a second indication of the network overload having been alleviated, the interference having been alleviated, or the network access having been regained has been obtained or not. If yes, step S212 is entered; and if no, step S208 is entered. One way to implement step S210 is to perform step S102b.

S212: Movement of the switch 170 is controlled such that the switch moves from the second position to the first position. One way to implement step S212 is to perform step S104b.

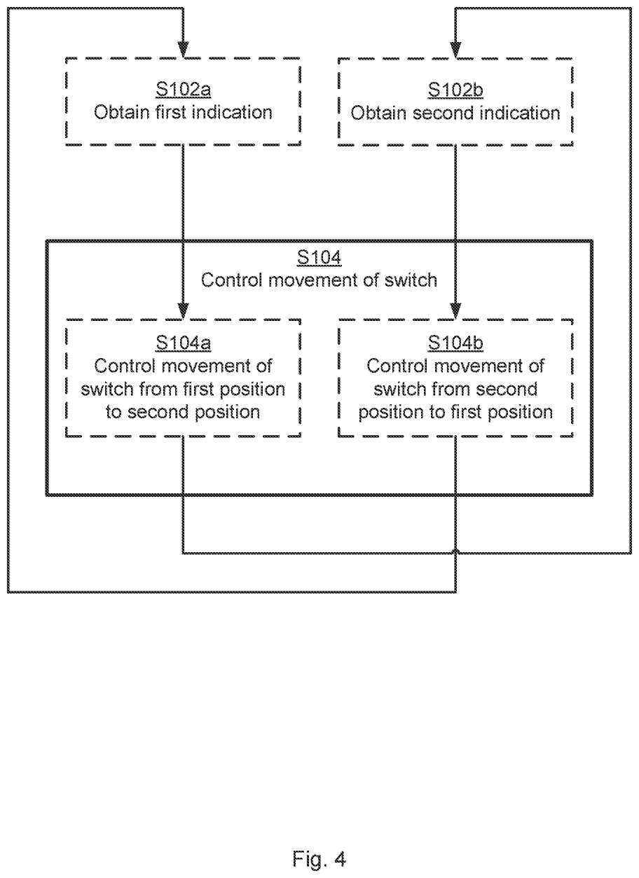

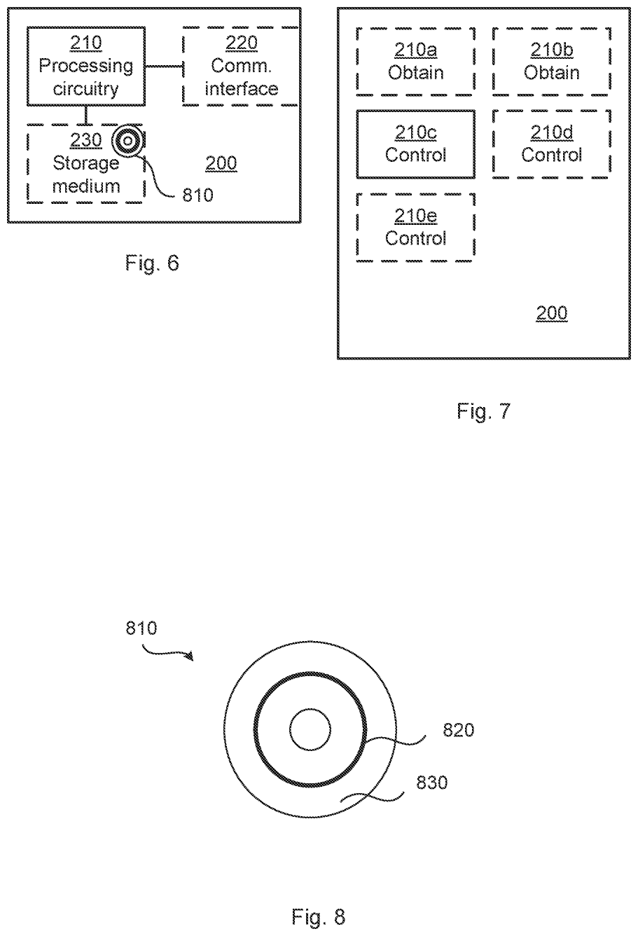

FIG. 6 schematically illustrates, in terms of a number of functional units, the components of a control node 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 810 (as in FIG. 8), e.g. in the form of a storage medium 230. The processing circuitry 210 may further be provided as at least one application specific integrated circuit (ASIC), or field programmable gate array (FPGA).

Particularly, the processing circuitry 210 is configured to cause the control node 200 to perform a set of operations, or steps, as disclosed above. For example, the storage medium 230 may store the set of operations, and the processing circuitry 210 may be configured to retrieve the set of operations from the storage medium 230 to cause the control node 200 to perform the set of operations. The set of operations may be provided as a set of executable instructions.

Thus the processing circuitry 210 is thereby arranged to execute methods as herein disclosed. The storage medium 230 may also comprise persistent storage, which, for example, can be any single one or combination of magnetic memory, optical memory, solid state memory or even remotely mounted memory. The control node 200 may further comprise a communications interface 220 at least configured for communications with the switch 160, and possible also at least one of: the first communication system 110, the second communication system 120 and the UAV 130. As such the communications interface 220 may comprise one or more transmitters and receivers, comprising analogue and digital components. The processing circuitry 210 controls the general operation of the control node 200 e.g. by sending data and control signals to the communications interface 220 and the storage medium 230, by receiving data and reports from the communications interface 220, and by retrieving data and instructions from the storage medium 230. Other components, as well as the related functionality, of the control node 200 are omitted in order not to obscure the concepts presented herein.

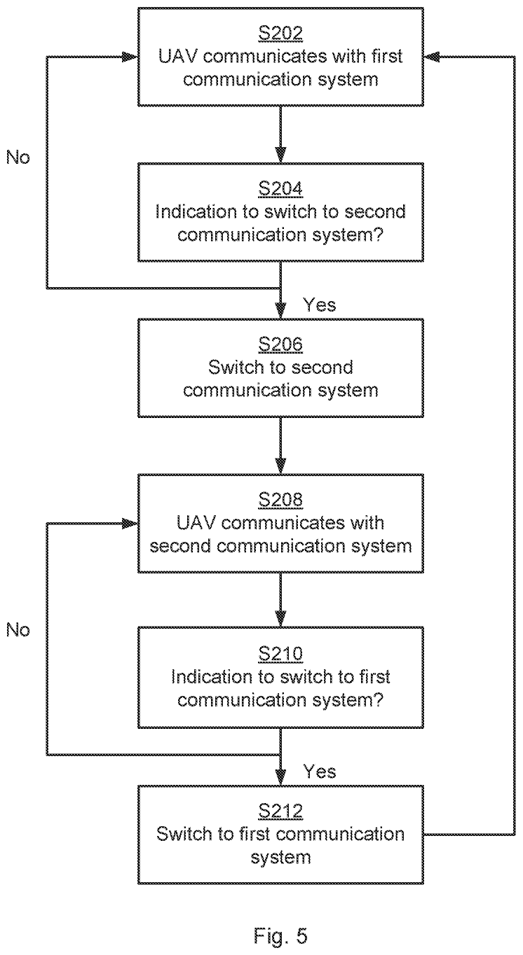

FIG. 7 schematically illustrates, in terms of a number of functional modules, the components of a control node 200 according to an embodiment. The control node 200 of FIG. 7 comprises a control module 210C configured to perform step S104. The control node 200 of FIG. 7 may further comprise a number of optional functional modules, such as any of an obtain module 210a configured to perform step S102a, an obtain module 210b configured to perform step S102b, a control module 210d configured to perform step S104a, and a control module 210e configured to perform step S104b. In general terms, each functional module 210a-210e may in one embodiment be implemented only in hardware and in another embodiment with the help of software, i.e., the latter embodiment having computer program instructions stored on the storage medium 230 which when run on the processing circuitry makes the control node 200 perform the corresponding steps mentioned above in conjunction with FIG. 7. It should also be mentioned that even though the modules correspond to parts of a computer program, they do not need to be separate modules therein, but the way in which they are implemented in software is dependent on the programming language used. Preferably, one or more or all functional modules 210a-210e may be implemented by the processing circuitry 210, possibly in cooperation with the communications interface 220 and/or the storage medium 230. The processing circuitry 210 may thus be configured to from the storage medium 230 fetch instructions as provided by a functional module 210a-210e and to execute these instructions, thereby performing any steps as disclosed herein.

The control node 200 may be provided as a standalone device or as a part of at least one further device. For example, the control node 200 may at least partly be provided in the UAV 130, at least partly in the first communication system 110, and/or at least partly in the second communication system 120. Alternatively, functionality of the control node 200 may be distributed between at least two devices, or nodes. These at least two nodes, or devices, may either be part of the UAV 130, the first communication system 110, and/or the second communication system 120, or may be spread between at least two of these. Thus, a first portion of the instructions performed by the control node 200 may be executed in a first device, and a second portion of the of the instructions performed by the control node 200 may be executed in a second device; the herein disclosed embodiments are not limited to any particular number of devices on which the instructions performed by the control node 200 may be executed. Hence, the methods according to the herein disclosed embodiments are suitable to be performed by a control node 200 residing in a cloud computational environment. Therefore, although a single processing circuitry 210 is illustrated in FIG. 6 the processing circuitry 210 may be distributed among a plurality of devices, or nodes. The same applies to the functional modules 210a-210e of FIG. 7 and the computer program 820 of FIG. 8.

FIG. 8 shows one example of a computer program product 810 comprising computer readable storage medium 830. On this computer readable storage medium 830, a computer program 820 can be stored, which computer program 820 can cause the processing circuitry 210 and thereto operatively coupled entities and devices, such as the communications interface 220 and the storage medium 230, to execute methods according to embodiments described herein. The computer program 820 and/or computer program product 810 may thus provide means for performing any steps as herein disclosed.

In the example of FIG. 8, the computer program product 810 is illustrated as an optical disc, such as a CD (compact disc) or a DVD (digital versatile disc) or a Blu-Ray disc. The computer program product 810 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 820 is here schematically shown as a track on the depicted optical disk, the computer program 820 can be stored in any way which is suitable for the computer program product 810.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. An unmanned aerial vehicle, UAV, the UAV comprising:
an antenna arrangement, the antenna arrangement comprising:
a first antenna array, the first antenna array having antenna elements pointing in a first direction;
a second antenna array, the second antenna array having antenna elements pointing in a second direction opposite the first direction;
a baseband unit; and
a switch configured to selectively connect the first antenna array and the second antenna array one at a time to the baseband unit,
wherein the antenna arrangement is arranged in the UAV such that the first direction equals the direction of gravitational force.

2. The UAV according to claim 1, wherein the antenna elements of the first antenna array have different antenna element spacing than the antenna elements of the second antenna array.

3. The UAV according to claim 1, wherein the first antenna array is configured to operate in a first frequency band, and wherein the second antenna array is configured to operate in a second frequency band, different from the first frequency band.

4. The UAV according to claim 1, wherein the switch in a first position connects the first antenna array to the baseband unit and in a second position connects the second antenna array to the baseband unit.

5. The UAV according to claim 4, wherein the switch as a default is positioned in at least one of the first position and the second position.

6. (canceled)

7. The UAV according to claim 4 further comprising:
a control node configured to control movement of the switch between the first position and the second position upon obtaining a control command.

8. The UAV according to claim 1, wherein the first antenna array is configured for communication with a first communication system of a first type, and the second antenna array is configured for communication with a second communication system of a second type, different from the first type.

9. The UAV according to claim 7, wherein the control node is configured to control movement of the switch from the first position to the second position upon the control command pertaining to a first indication of: network overload in the first communication system, interference in the first communication system being above an interference threshold value, or lost network access to the first communication system.

10. The UAV according to claim 9, wherein the interference is caused by the UAV.

11. The UAV according to claim 9, wherein the control node is configured to control movement of the switch from the second position to the first position upon the control command pertaining to a second indication of: the network overload having been alleviated, the interference having been alleviated, or the network access having been regained.

12. The UAV according to claim 8, wherein the first communication system is a terrestrial based communication system, the terrestrial based communication system comprising a cellular communication system.

13. (canceled)

14. The UAV according to claim 8, wherein the second communication system is a space based communication system, the space based system comprising a satellite communication system.

15. (canceled)

16. The UAV according to claim 1, further comprising:
sets of rotor blades,
wherein the antenna arrangement and the sets of rotor blades are mutually arranged in the UAV for the second antenna array to have free line of sight in the second direction.

17. The UAV according to claim 1, wherein at least one of the first antenna array and the second antenna array is configured for communication using beam-formed beams.

18. The UAV according to claim 1, wherein at least one of the first antenna array and the second antenna array is a uniform linear array, a uniform rectangular array, or a panel.

19. A method for controlling an unmanned aerial vehicle, UAV, according to claim 1, wherein the switch in a first position connects the first antenna array to the baseband unit and in a second position connects the second antenna array to the baseband unit, the method being performed by a control node, the method comprising:
controlling movement of the switch between the first position and the second position according to a control command.

20. The method according to claim 19, wherein the first antenna array is configured for communication with a first communication system of a first type, and the second antenna array is configured for communication with a second communication system of a second type, different from the first type.

21. The method according to claim 20, further comprising:
obtaining a first indication of: network overload in the first communication system, interference in the first communication system being above an interference threshold value in the first communication system, or lost network coverage to the first communication system; and wherein the control command pertains to:
controlling movement of the switch from the first position to the second position in response thereto.

22. The method according to claim 21, further comprising:
obtaining a second indication of: the network overload having been alleviated, the interference having been alleviated, or the network coverage having been regained; and wherein the control command pertains to:
controlling movement of the switch from the second position to the first position in response thereto.

23. A control node for controlling an unmanned aerial vehicle, UAV, the UAV comprising:
an antenna arrangement, the antenna arrangement comprising:
a first antenna array, the first antenna array having antenna elements pointing in a first direction;
a second antenna array, the second antenna array having antenna elements pointing in a second direction opposite the first direction;
a baseband unit; and
a switch configured to selectively connect the first antenna array and the second antenna array one at a time to the baseband unit,
wherein the antenna arrangement is arranged in the UAV such that the first direction equals the direction of gravitational force, wherein the switch in a first position connects the first antenna array to the baseband unit and in a second position connects the second antenna array to the baseband unit, the control node comprising processing circuitry, the processing circuitry being configured to cause the control node to:
control movement of the switch between the first position and the second position according to a control command.

24. (canceled)

25. (canceled)
